(19) United States
(12) Patent Application Publication
(10) Pub. No.: US 2023/0235201 A1
(43) Pub. Date: Jul. 27, 2023

(54) PSA FILM, LAMINATE, AND METHOD FOR USING PSA FILM

(71) Applicant: DIC Corporation, Tokyo (JP)

(72) Inventors: Mai Hasebe, Saitama (JP); Daichi Katano, Saitama (JP); Hideaki Takei, Saitama (JP); Tatsuya Egashira, Chiba (JP); Yusuke Takahashi, Tokyo (JP)

(73) Assignee: DIC Corporation, Tokyo (JP)

(21) Appl. No.: 18/159,230

(22) Filed: Jan. 25, 2023

(30) Foreign Application Priority Data
Jan. 27, 2022 (JP) 2022-010800
Dec. 8, 2022 (JP) 2022-196225

(51) Int. Cl. C09J 7/38; C09J 7/40; C09J 7/25; B32B 7/12; B32B 27/36; B32B 27/08

(52) U.S. Cl. CPC C09J 7/385; B32B 7/12; B32B 27/08; B32B 27/36; C09J 7/255; C09J 7/405; B32B 2250/02; B32B 2250/244; B32B 2255/10; B32B 2255/26; B32B 2307/734; C09J 2433/00; C09J 2467/005; C09J 2467/006

(57) ABSTRACT

A PSA film includes a base material and a PSA layer on at least one side of the base material. The PSA layer has a temperature region, within the range of 70° C. to 100° C., in which its loss tangent tanδ is 0.8 or greater. The PSA film can be peeled off through irradiation with active energy radiation.

### CROSS REFERENCES TO RELATED APPLICATIONS

One or more embodiments of the present invention contains subject matter related to Japanese Patent Application No. 2022-010800 filed in the Japan Patent Office on Jan. 27, 2022, the entire contents of which are incorporated herein by reference.

### TECHNICAL FIELD

One or more embodiments of the present invention relates to, for example, a pressure-sensitive adhesive (PSA) film suitable for use in the transport, surface protection, etc., of resin films that require annealing, such as optical films.

### BACKGROUND

Articles in the fields of displays, electronics, batteries and energy, on-board (automotive) equipment, etc., are made with industrial films so that the articles will be given desired functions or the films themselves will perform their desired functions. For example, optical films in the field of displays, such as polarizing films and retarder films, are used as components of image display devices, such as liquid-crystal displays and OLED displays for electronic devices like smartphones and tablet computers.

In the processes of production and processing, transport, inspection, etc., of an article in such fields, a PSA film is attached to the surface of an industrial film that is to be incorporated in the article, for purposes such as transporting the industrial film and protecting the industrial film from damage and contamination. The PSA film is removed by being peeled off the industrial film when it is no longer necessary. For example, Japanese Unexamined Patent Application Publication No. 2013-216738 discloses a PSA film for surface protection and the transport of an optical film during the production of a display device. Such a PSA film may be referred to as a protective film, a process film, etc., according to its method of use.

A resin film used as an industrial film is usually annealed so that residual stress and strain that have been created in it in the course of shaping will be removed and relieved, respectively. The removal of residual stress and strain involves deformation of the resin film, but if a PSA film has been attached to the resin film before the annealing, the deformation of the resin film is inhibited because the PSA film restricts it, and the residual stress and strain are not sufficiently relieved even after the annealing, causing faults in downstream processing steps.

The temperature to which the resin film is heated in the annealing and the duration of annealing, furthermore, are selected according to the glass transition temperature of the resin film. The PSA film attached to the resin film needs not to easily come off even under the conditions of the annealing of the resin film but needs to be easy to peel off the resin film after the annealing.

### SUMMARY

An aspect of one or more embodiments of the present invention, therefore, is to provide a PSA film that allows for the annealing of a resin film temporarily secured with it without interfering with the relief of residual stress and strain in the resin film, does not easily come off the resin film during the annealing, and can be easily peeled off after the annealing, leaving no adhesive.

One or more embodiments of the present invention include the following aspects.

A PSA film including a base material and a PSA layer on at least one side of the base material, wherein the PSA layer has a temperature region, within a range of 70° C. to 100° C., in which a loss tangent tanδ thereof at a frequency of 1 Hz is 0.8 or greater; and the PSA film is configured to be peeled off through irradiation with active energy radiation.

[2] A PSA film including a base material and a PSA layer on at least one side of the base material, wherein the PSA layer is a layer of a PSA composition containing an acrylic copolymer and an active energy radiation-curable compound and has a temperature region, within a range of 70° C. to 100° C., in which a loss tangent tanδ thereof at a frequency of 1 Hz is 0.8 or greater.

[3] The PSA film according to [1] or [2] above, wherein a gel fraction of the PSA layer is 50% by mass or less.

[4] The PSA film according to any of [1] to [3] above, wherein a stress in the base material at 100% elongation at 150° C. is from 5 MPa to 60 MPa.

[5] The PSA film according to any of [1] to [4] above for use by being attached to a resin film.

[6] The PSA film according to any of [1] to [5] above for use in surface protection.

[7] The PSA film according to any of [1] to [6] above for use in carrier.

[8] A laminate including the PSA film according to any of [1] to [7] above and a resin film on the PSA layer of the PSA film.

[9] The laminate according to [8] above, wherein the resin film is an optical film.

[10] A method for using a PSA film, the method including the following in the indicated order: attaching a resin film to the PSA layer of the PSA film according to any of [1] to [7] above to obtain a laminate; annealing the resin film of the laminate; and irradiating the laminate after the annealing with active energy radiation to peel the PSA film off the resin film.

### BRIEF DESCRIPTION OF THE DRAWINGS

FIG. 1 is a schematic cross-sectional diagram illustrating an example of a PSA film according one or more embodiments of the present invention;

FIG. 2 is a schematic cross-sectional diagram illustrating an example of a laminate according to one or more embodiments of the present invention;

FIGS. 3A to 3C are illustrations for the description of the method of the curl test performed in examples and comparative examples;

FIG. 4 is an illustration for the description of the method of the thermoforming test performed in examples and comparative examples;

FIGS. 5A-5C are illustrations for the description of the method of the thermoforming test performed in examples and comparative examples; and

FIG. 6 is an illustration for the description of the method of the thermoforming test performed in examples and comparative examples.

### DETAILED DESCRIPTION OF THE EMBODIMENTS

As used herein, “(meth)acrylic” refers to acrylic or methacrylic. “(Meth)acrylate” refers to an acrylate or methacrylate. The loss tangent tanδ may be written simply as tanδ.

### 1. PSA Film

A pressure-sensitive adhesive (PSA) film according to one or more embodiments of the present invention includes a base material and a PSA layer on at least one side of the base material. The PSA layer has a temperature region, within the range of 70° C. to 100° C., in which its loss tangent tanδ is 0.8 or greater, and the PSA film can be peeled off through irradiation with active energy radiation.

In other words, a PSA film according to one or more embodiments includes a base material and a PSA layer on at least one side of the base material, and the PSA layer is a layer of a PSA composition containing an acrylic copolymer and an active energy radiation-curable compound, and has a temperature region, within the range of 70° C. to 100° C., in which its loss tangent tanδ is 0.8 or greater.

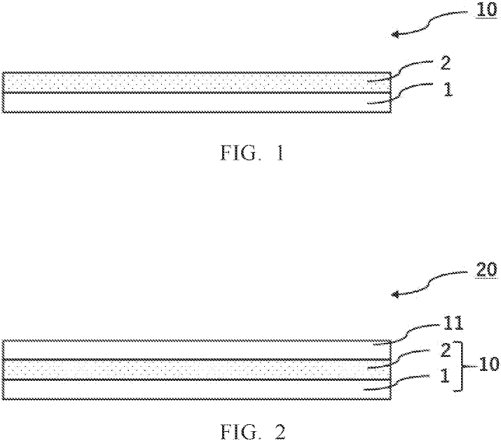

FIG. 1 is a schematic cross-sectional diagram illustrating an example of a PSA film according to one or more embodiments of the present invention, in which the PSA film includes a base material 1 and a PSA layer 2 on one side of the base material 1. The PSA layer 2 has a temperature region, within the range of 70° C. to 100° C., in which its loss tangent tanδ is 0.8 or greater. The PSA layer 2, furthermore, cures when irradiated with active energy radiation, allowing the PSA film to be peeled off. In other words, the PSA layer 2 is a layer of a PSA composition containing an acrylic copolymer and an active energy radiation-curable compound.

In annealing a resin film, the temperature to which the film is heated and the duration of heating are selected according to the resin used and its characteristics (e.g., the glass transition temperature of the resin). In particular, resin films that are used as, for example, optical films are annealed at temperatures around 100° C. so that damage to the function of the resin films from the heat of annealing will be limited. If a PSA film has been attached before the annealing, however, the resin film is restricted by the PSA film, and the resulting insufficient relief of residual stress and strain affects the workability and optical characteristics of the annealed resin film.

To address this, the PSA film according to one or more embodiments has a PSA layer that has a temperature region, within the range of 70° C. to 100° C., in which its loss tangent tanδ is 0.8 or greater. This ensures the PSA layer will be flexible and fluidic under the temperature conditions of the annealing of the resin film. In that case the PSA layer does not interfere with the deformation of the resin film that occurs during the annealing, helping achieve sufficient relief of residual stress and strain in the resin film with an attached PSA film on it.

The PSA film according to one or more embodiments, furthermore, is highly adhesive until it is irradiated with active energy radiation. This means the PSA film does not easily come off the resin film even when exposed to heat as a result of the annealing, but when it is peeled off the resin film after the annealing, it can be easily peeled off through irradiation with active energy radiation, leaving no adhesive.

By virtue of the above characteristics of its PSA layer, the PSA film according to one or more embodiments does not interfere with the deformation of the resin film associated with the relief of residual stress and strain in it, whether the resin film is annealed at a temperature around 100° C., e.g., in the temperature region of 70° C. to 100° C. (also referred to as the low-temperature region), or in the temperature region of over 100° C. (also referred to as the high-temperature region); in either case, the PSA layer is flexible and fluidic. The PSA layer, furthermore, keeps the adhesion between the PSA film and the resin film until irradiation with active energy radiation and becomes highly releasable once it is irradiated with active energy radiation. Overall, attaching the PSA film according to one or more embodiments to an optical or other functional resin film before annealing it in the low-temperature region is a way to protect the surface of and/or transport the resin film while relieving residual stress and strain in the resin film with an attached PSA film on it at the same time. Damage to the function of the resin film from the annealing is also prevented.

In one or more embodiments, the tanδ of the PSA layer is that of the PSA layer before the annealing of the resin film and before curing (before irradiation with active energy radiation) unless stated otherwise. Likewise, characteristics of the PSA layer other than tanδ are those of the PSA layer before the annealing of the resin film and before curing (before irradiation with active energy radiation) unless stated otherwise.

### PSA Layer

The PSA layer in one or more embodiments is on at least one side of a base material. The PSA layer may be directly on the surface of the base material, or there may be another layer between the PSA layer and the surface of the base material.

The PSA layer in one or more embodiments, furthermore, is a layer that is less adhesive after irradiation with active energy radiation than before irradiation with active energy radiation. A feature of the PSA layer in one or more embodiments is that it is highly adhesive until it is irradiated with active energy radiation, but once irradiated with active energy radiation, it loses its adhesion as curing reaction proceeds. The PSA layer in one or more embodiments, therefore, is a layer of a PSA composition that cures when exposed to active energy radiation (also referred to as an active energy radiation-curable PSA composition).

The active energy radiation only needs to be one with which the PSA layer can be cured. The active energy radiation can be, for example, light, such as far-ultraviolet, ultraviolet, near-ultraviolet, or infrared radiation, electromagnetic radiation, such as an X-ray or γ-ray, or an electron beam, a proton beam, or a neutron beam. Of these, ultraviolet radiation is particularly preferred because it cures the PSA layer rapidly and because irradiation with it only involves a simple operation and simple equipment.

The PSA layer in one or more embodiments has a temperature region, within the range of 70° C. to 100° C., in which its loss tangent tanδ is 0.8 or greater. By virtue of having a temperature region, within the above temperature range, in which it has a predetermined tanδ, the PSA layer is highly flexible and highly fluidic under the conditions under which the resin film is annealed with the PSA film attached to it. This ensures the PSA layer will not interfere with the deformation of the resin film that occurs during the annealing, thereby helping achieve sufficient relief of residual stress and strain in the resin film with an attached PSA film on it.

The PSA layer only needs to have the temperature region in which its tanδ is 0.8 or greater within the range of 70° C. to 100° C. The PSA layer may have the temperature region in which its tanδ is 0.8 or greater within the range of 80° C. to 100° C. The PSA layer may have the temperature region in which its tanδ is 0.8 or greater within the range of 85° C. to 100° C., or within the range of 90° C. to 100° C. The presence of the temperature region in which the tanδ is 0.8 or greater within these temperature ranges helps prevent the PSA layer from interfering with the deformation of the resin film that occurs during the annealing in association with the relief of residual stress and strain in it, and also helps ensure that the PSA layer will retain its shape.

Because of having a temperature region, within the range of 70° C. to 100° C., in which its tanδ is 0.8 or greater, the PSA layer in one or more embodiments has a tanδ of 0.8 or greater in the temperature range of over 100° C., too. By virtue of this, the PSA layer does not interfere with the deformation of the resin film associated with the relief of residual stress and strain in it, and therefore residual stress and strain in the resin film are successfully relieved, whether the resin film is annealed in the temperature region of 100° C. or below or in the temperature region of over 100° C.

The PSA layer, furthermore, only needs to have a temperature region in which its tanδ is 0.8 or greater, or 0.80 or greater, within the range of 70° C. to 100° C. The PSA layer may have a temperature region in which its tanδ is 0.87 or greater, or 0.93 or greater, within the same range. The PSA layer has a temperature region in which its tanδ is 1.0 or greater within the same range because in that case the PSA layer is more flexible and more fluidic under the conditions of the annealing of the resin film; the PSA layer, therefore, does not interfere with the relief of residual stress and strain in the resin film, and residual stress and strain in the resin film are relieved successfully. There is no particular upper limit to the tanδ of the PSA layer within the range of 70° C. to 100° C. as long as the PSA layer is flexible and fluidic and retains its shape at the same time under the conditions of the annealing of the resin film, but for example, the tanδ can be 2.0 or less. The tanδ may be 1.5 or less because this helps improve the suitability for working and the shape retention of the PSA film while achieving the relief of residual stress and strain in the resin film. The tanδ can be 1.3 or less.

The PSA layer may have a tanδ of 0.80 or greater in the temperature region of 75° C. to 100° C. so that it will be flexible and fluidic and retain its shape at the same time under the conditions of the annealing of the resin film with the PSA film according to one or more embodiments attached to it. The tanδ in the same temperature region may be 0.87 or greater, 0.93 or greater, or 1.0 or greater. The tanδ in the same temperature region may be 2.0 or less, or 1.5 or less.

The PSA layer may be one in which its tanδ is 0.80 or greater in the temperature region of 80° C. to 100° C. The tanδ in the same temperature region may be 0.87 or greater, 0.93 or greater, or 1.0 or greater. The tanδ in the same temperature region may be 2.0 or less, 1.5 or less, or 1.3 or less.

The PSA layer may be one in which its tanδ of 0.80 or greater in the temperature region of 85° C. to 100° C. The tanδ in the same temperature region may be 0.87 or greater, 0.93 or greater, or 1.0 or greater. The tanδ in the same temperature region may be 2.0 or less, 1.5 or less, or 1.3 or less.

The PSA layer may be one in which its tanδ is 0.80 or greater in the temperature region of 90° C. to 100° C. The tanδ in the same temperature region may be 0.87 or greater, 0.93 or greater, or 1.0 or greater. The tanδ in the same temperature region may be 2.0 or less, 1.5 or less, or 1.3 or less.

The PSA layer may be one in which its loss tangent at 90° C., tanδ (90° C.), is 0.8 or greater. The tanδ (90° C.) may be 0.80 or greater, or 0.87 or greater. A tanδ (90° C.) of 0.93 or greater helps ensure that the PSA layer will retain its shape well and at the same time be highly flexible and highly fluidic even under the temperature conditions of the annealing of the resin film, thereby helping limit the interference of the PSA layer with the relief of residual stress and strain in the resin film.

The maximum loss tangent tanδ of the PSA layer in the temperature region of 50° C. to 70° C. excluding 70° C. may be 1.5 or less, 1.3 or less, or 1.0 or less; this helps prevent the PSA layer from becoming excessively fluidic and losing its shape stability under the temperature conditions under which the resin film is annealed with the PSA film attached to it.

The loss tangent tanδ of the PSA layer can be adjusted by, for example, adjusting the gel fraction of the PSA composition that forms the PSA layer, adjusting the crosslinking agent content of the PSA composition, reducing the weight-average molecular weight of the acrylic copolymer in the PSA composition, and increasing the amount, in the PSA composition, of the active energy radiation-curable compound (e.g., urethane (meth)acrylate).

The loss tangent tanδ of the PSA layer is the ratio of the loss modulus G″ to the storage modulus G′ of the PSA composition with which the PSA layer is formed. That is, tanδ = G″/G′. The loss tangent tanδ of the PSA layer can be determined as follows. The PSA composition with which the PSA layer is formed is coated onto the surface of release liners, and the resulting coatings are heated at 85° C. for 5 minutes using an oven to give PSA layers a, layers having a thickness of 50 µm. PSA layers a are stacked to give PSA layer A, a layer having a total thickness of 2 mm. PSA layer A is cut into an 8-mm diameter disk for use as a test specimen. The test specimen is placed between a rheometer’s (Rheometrics; trade name, ARES 2KSTD) parallel plates, which constitute the measuring section of the rheometer, and the storage modulus (G′) and loss modulus (G″) at a frequency of 1 Hz are measured at a heating rate of 2.0° C./min in the temperature range of -40° C. to 150° C. in a mode for shear stress measurement. The G′ and G″ at different temperatures can be used to calculate the loss tangent tanδ at the respective temperatures.

The gel fraction in toluene of the PSA layer (gel fraction before irradiation with active energy radiation) may be 50% by mass or less, may be in the range of 10% by mass to 40% by mass, or may be in the range of 15% by mass to 35% by mass. Making the gel fraction of the PSA layer within these ranges ensures this layer will be highly adhesive to the resin film at room temperature and under the conditions of the annealing until it is irradiated with active energy radiation. Making the gel fraction of the PSA layer within these ranges, furthermore, ensures the PSA layer will not interfere with the deformation of the resin film that occurs during the annealing, thereby helping achieve sufficient relief of residual stress and strain in the resin film with an attached PSA film on it.

The gel fraction of the PSA layer and of the PSA composition that forms the PSA layer is a value measured by the following method.

### Measuring Method

The PSA composition is coated onto the release-agent side of a release liner to the extent that the thickness of the dried coating will be 10 µm. The coating is dried for 5 minutes under 85° C. conditions and aged for 2 days under 40° C. conditions to give a PSA layer, and this PSA layer is cut into a square of 50 mm long and 50 mm wide for use as a test specimen. The mass of the test specimen, mass (G1), is measured, and then the test specimen is immersed in toluene for 24 hours under 23° C. conditions. After the immersion, the mixture of the test specimen and toluene is filtered through a 300-mesh metal sieve so that insoluble matter in the toluene will be isolated. The insoluble matter is dried for 1 hour under 110° C. conditions, and the mass of the dried matter, mass (G2), is measured. The gel fraction is calculated from mass (G1) and mass (G2) according to the following equation.

$$\text{Gel fraction} \left(\% \text{by mass}\right) = \left(\text{G2} / \text{G1}\right) \times 100$$

The gel fraction in toluene of the PSA layer after irradiation with active energy radiation may be in the range of 80% by mass or more, may be 80% by mass or more and 98% by mass or less, or may be 85% by mass or more and 98% by mass or less. Making the gel fraction of the PSA layer after irradiation with active energy radiation within these ranges ensures the PSA film will be easy to peel off with a light load.

The gel fraction of the PSA layer after irradiation with active energy radiation can be measured in the same way as in the above method, except that a PSA layer formed as in the above measuring method for gel fraction is irradiated with active energy radiation under the following conditions and then cut into a square of 50 mm long and 50 mm wide for use as a test specimen.

### Conditions for Irradiation With Active Energy Radiation

Light source: Heraeus’s electrodeless lamp bulb, D Bulb
Irradiance: 90 mW/cm²
Exposure: 180 mJ/cm²
Irradiance and exposure meter: Orc Manufacturing’s “ORC UV-M10 measuring instrument”

The PSA layer in one or more embodiments is a layer of an active energy radiation-curable PSA composition containing ingredients for forming it. The PSA composition that forms the PSA layer in one or more embodiments can be any composition that is moderately adhesive until it is irradiated with active energy radiation and cures and loses part or all of its adhesion in response to irradiation with active energy radiation, may be one that contains a PSA resin as its base ingredient. The base ingredient of a PSA composition refers to the most abundant one of the ingredients contained in the PSA composition.

To perform the function of losing part or all of its adhesion in response to irradiation with active energy radiation, the PSA composition may have a chemical makeup including a PSA resin and an active energy radiation-curable compound or may have a chemical makeup in which the PSA resin itself cures in response to active energy radiation. Even if the PSA resin itself cures in response to active energy radiation, the PSA composition may have a chemical makeup including the active energy radiation-curable PSA resin and other active energy radiation-curable compound(s). The PSA composition may have a chemical makeup including a PSA resin and an active energy radiation-curable compound because this makes more certain that the composition meets the characteristics requirements before and after irradiation; in that case the PSA composition is moderately adhesive by virtue of the PSA resin until it is irradiated with active energy radiation, and once irradiated, the composition becomes releasable by losing its adhesion to a sufficient degree as a result of the curing of the active energy radiation-curable compound.

If the PSA resin itself cures in response to active energy radiation, an active energy radiation-polymerizable group is introduced into the PSA resin. The active energy radiation-polymerizable group may be introduced into the main chain or a side chain of the PSA resin. It should be noted that PSA resins having an active energy radiation-polymerizable group may be referred to as active energy radiation-curable PSA resins so that they can be distinguished from PSA resins having no active energy radiation-polymerizable group.

### PSA Resin

The PSA resin is an ingredient for ensuring, for example, the peel strength of the PSA layer. The PSA resin can be of any kind, and examples include copolymers (polymers) such as acrylic copolymers, polyurethanes, rubber polymers, polyolefin polymers, and silicones. Of these, the PSA resin may be an acrylic copolymer. In other words, the PSA layer may be a layer of an active energy radiation-curable PSA composition containing an acrylic copolymer.

An acrylic copolymer is obtained by copolymerizing monomer components including an alkyl (meth)acrylate as the base monomer. The alkyl (meth)acrylate may be a (meth)acrylate having an alkyl group with 1 to 20 carbon atoms. The number of carbon atoms in the alkyl group may be from 1 to 12, from 1 to 9, or from 4 to 9. Too many carbon atoms in the alkyl group can cause the adherend to be easily contaminated by adhesive residue when the PSA film is peeled off after irradiation with active energy radiation. The alkyl group may be linear-chain or may be branched.

Specific examples of alkyl (meth)acrylates include monomers such as methyl (meth)acrylate, ethyl (meth)acrylate, n-butyl (meth)acrylate, isobutyl (meth)acrylate, t-butyl (meth)acrylate, n-hexyl (meth)acrylate, n-octyl (meth)acrylate, isooctyl (meth)acrylate, isononyl (meth)acrylate, cyclohexyl (meth)acrylate, and 2-ethylhexyl (meth)acrylate. One such monomer may be used alone, or two or more may be used in combination. Of these, methyl (meth)acrylate, n-butyl (meth)acrylate, and 2-ethylhexyl (meth)acrylate are particularly preferred for reasons such as copolymerizability and PSA properties.

The alkyl (meth)acrylate content of the acrylic copolymer may be from 10% to 99% by mass, from 30% to 99% by mass, from 50% to 99% by mass, from 80% to 98.5% by mass, or from 90% to 98.5% by mass of the monomer components constituting the acrylic copolymer. Making the alkyl (meth)acrylate content within these ranges helps prevent peel strength before irradiation with active energy radiation from being too low or too high, thereby helping achieve good adhesion to the resin film.

Alternatively, the acrylic copolymer may be a copolymer of an alkyl (meth)acrylate and a highly polar monomer. Examples of highly polar monomers for the copolymerization with the alkyl (meth)acrylate include hydroxyl-containing monomers, carboxyl-containing monomers, and amide-containing monomers. One such monomer may be used alone, or two or more may be used in combination.

Examples of hydroxyl-containing monomers suitable for use include hydroxyl-containing (meth)acrylates, such as 2-hydroxyethyl (meth)acrylate, 2-hydroxypropyl (meth)acrylate, 4-hydroxybutyl (meth)acrylate, and 6-hydroxyhexyl (meth)acrylate. One such monomer may be used alone, or two or more may be used in combination. Of these, 2-hydroxyethyl (meth)acrylate and 4-hydroxybutyl (meth)acrylate are particularly preferred because of their reactivity with crosslinking agents.

The amount of the hydroxyl-containing monomer(s) in the acrylic copolymer may be from 0.1% to 40% by mass, from 0.2% to 30% by mass, or from 0.5% to 30% by mass of the monomer components constituting the acrylic copolymer. Making the amount of the hydroxyl-containing monomer(s) within these ranges helps prevent the resin film from being contaminated, for example by adhesive residue, when the PSA film is peeled off after irradiation with active energy radiation.

Examples of carboxyl-containing monomers that can be used include (meth)acrylic acid, itaconic acid, maleic acid, fumaric acid, the (meth)acrylic acid dimer, crotonic acid, and ethoxylated succinic acid acrylates. One such monomer may be used alone, or two or more may be used in combination. Of these, acrylic acid and methacrylic acid are particularly preferred for copolymerizability reasons.

The amount of the carboxyl-containing monomer(s) in the acrylic copolymer may be 10% by mass or less, 5% by mass or less, 1% by mass or less, in particular 0.3% by mass or less of the monomer components constituting the acrylic copolymer. Furthermore, the amount of the carboxyl-containing monomer(s) may be 0.01% by mass or more, 0.03% by mass or more, or 0.05% by mass or more of the monomer components constituting the acrylic copolymer. Making the amount of the carboxyl-containing monomer(s) within these ranges helps prevent the resin film from deteriorating and the surface of the resin film from being contaminated, for example by adhesive residue, when the PSA film is peeled off after irradiation with active energy radiation.

Examples of amide-containing monomers include N-vinylpyrrolidone, N-vinylcaprolactam, acryloylmorpholine, acrylamide, and N,N-dimethylacrylamide.

Examples of other highly polar vinyl monomers include vinyl acetate, ethoxylated succinic acid acrylates, sulfonic acid-containing monomers, such as 2-acrylamide-2-methylpropanesulfonic acid, and terminally alkoxy-modified (meth)acrylates, such as 2-methoxyethyl (meth)acrylate and 2-phenoxyethyl (meth)acrylate.

An acrylic copolymer can be obtained by copolymerizing monomers by a known polymerization method, such as solution polymerization, suspension polymerization, bulk polymerization, or emulsion polymerization. Of these, solution polymerization or bulk polymerization is particularly preferred because of the water resistance of the PSA composition.

An example of a process for preparing an acrylic copolymer by solution polymerization is simply to mix monomer components including an alkyl (meth)acrylate and a polymerization initiator into an organic solvent or add the materials into the organic solvent dropwise and then polymerize the monomers for about 0.1 to 20 hours under reflux, usually at 50° C. to 98° C.

Examples of organic solvents used in this polymerization reaction include aromatic hydrocarbons, such as toluene and xylene, aliphatic hydrocarbons, such as hexane, esters, such as ethyl acetate and butyl acetate, aliphatic alcohols, such as n-propyl alcohol and isopropyl alcohol, and ketones, such as acetone, methyl ethyl ketone, methyl isobutyl ketone, and cyclohexanone.

The polymerization initiator can be an ordinary radical polymerization initiator. Specific examples include azo polymerization initiators, such as azobisisobutyronitrile and azobisdimethylvaleronitrile, and peroxide polymerization initiators, such as benzoyl peroxide, lauroyl peroxide, di-tert-butyl peroxide, and cumene hydroperoxide.

The weight-average molecular weight of the acrylic copolymer may be 100,000 or more and 1,000,000 or less. Too small a weight-average molecular weight of the acrylic copolymer causes the surface of the resin film to be contaminated, for example by adhesive residue, when the PSA film is peeled off after irradiation with active energy radiation, and too large a weight-average molecular weight of the acrylic copolymer can affect coating property.

The molecular weight in this context is a standard polystyrene-equivalent molecular weight measured by GPC using Tosoh Corporation’s GPC (HLC-8329GPC). The measuring conditions are as follows.
Sample concentration: 0.5% by mass (solution in THF)
Sample injection volume: 100 µL
Eluent: THF
Flow rate: 1.0 mL/min
Measuring temperature: 40° C.
Main columns: Two TSKgel GMHHR-H (20) columns
Guard column: TSKgel HXL-H
Detector: A differential refractometer
Standard polystyrene molecular weights: 10,000 to 20,000,000 (Tosoh Corporation)

If the PSA resin itself cures in response to active energy radiation, it can be an active energy radiation-curable PSA resin, i.e., a PSA resin with an introduced active energy radiation-polymerizable group in it.

An example of an active energy radiation-polymerizable group is a group containing an active energy radiation-polymerizable carbon-carbon double bond, and a specific example is the (meth)acryloyl group. There may be an alkylene, alkyleneoxy, or polyalkyleneoxy group between the active energy radiation-polymerizable group and the PSA resin.

The active energy radiation-curable PSA resin can be of any kind, and an example is a PSA resin as described above, i.e., a PSA resin with an introduced active energy radiation-polymerizable group in it. An example of a particularly preferred one is an acrylic resin with an introduced active energy radiation-polymerizable group in it.

An example of how to obtain an acrylic resin with an introduced active energy radiation-polymerizable group in it is to allow an acrylic copolymer containing a functional group such as a hydroxyl, carboxyl, amino, substituted amino, or epoxy group to react with a polymerizable group-containing compound having a substituent reactive with the functional group and one to five active energy radiation-polymerizable carbon-carbon double bonds per molecule. Examples of polymerizable group-containing compounds include (meth)acryloyloxyethyl isocyanate, meta-isopropenyl-α,α-dimethylbenzyl isocyanate, (meth)acryloyl isocyanate, allyl isocyanate, and glycidyl (meth)acrylate, and (meth)acrylic acid.

### Active Energy Radiation-Curable Compound(s)

The active energy radiation-curable compound contained in the PSA composition can be any compound that polymerizes in response to irradiation with active energy radiation, and examples include compounds having an active energy radiation-polymerizable group (monofunctional or polyfunctional monomers and oligomers). An example of such an active energy radiation-curable compound is an active energy radiation-curable compound containing two or more ethylenically unsaturated groups (i.e., an ethylenically unsaturated compound).

Specific examples of active energy radiation-curable compounds include a urethane (meth)acrylate compound, an epoxy (meth)acrylate compound, a polyester (meth)acrylate compound, a polyether (meth)acrylate compound, and a polyfunctional ethylenically unsaturated monomer having two or more ethylenically unsaturated groups in one molecule of it other than these acrylate compounds. One such compound may be used alone, or two or more may be used in combination.

Of these, the active energy radiation-curable compound(s) may be a urethane (meth)acrylate compound and/or a polyfunctional ethylenically unsaturated monomer because these compounds are superior in reactivity in response to irradiation with active energy radiation and releasability after the irradiation.

The weight-average molecular weight of the active energy radiation-curable compound(s) may be 10000 or less, 5000 or less, or 1000 or less, although this depends partly on the active energy radiation-curable compound(s) used. The weight-average molecular weight of the active energy radiation-curable compound(s) may be 100 or more, 300 or more, or 500 or more.

The number of ethylenically unsaturated groups per molecule of the active energy radiation-curable compound(s) only needs to be 2 or greater and can be selected according to the active energy radiation-curable compound(s) used. The number of ethylenically unsaturated groups may be 3 or greater, from 3 to 60, or from 3 to 40. Too few ethylenically unsaturated groups can affect releasability because in that case the PSA layer can lose little of its peel strength even when irradiated with active energy radiation.

The amount of the active energy radiation-curable compound(s) in the PSA composition is not critical as long as the PSA layer is highly adhesive until it is irradiated with active energy radiation and loses its adhesion sufficiently or completely when irradiated with active energy radiation. For example, it may be 5 parts by weight or more, 10 parts by weight or more, or 20 parts by weight or more per 100 parts by weight of the PSA resin. The amount of the active energy radiation-curable compound(s) may be 200 parts by weight or less, 100 parts by weight or less, or 80 parts by weight or less per 100 parts by weight of the PSA resin. Making the amount of the active energy radiation-curable compound(s) in the PSA composition within these ranges ensures the PSA film will lose its peel strength and become easy to peel off shortly after irradiation with active energy radiation, and also helps prevent the surface of the resin film from being contaminated, for example by adhesive residue, when the PSA film is peeled off.

### Urethane (Meth)acrylate Compound(s)

A urethane (meth)acrylate compound is a compound having a urethane linkage and a terminal (meth)acryloyl group. A urethane (meth)acrylate compound cures in response to active energy radiation by virtue of the action of its (meth)acryloyl group.

The urethane (meth)acrylate compound can be the product of reaction between a hydroxyl-containing (meth)acrylate and a polyfunctional isocyanate compound. Alternatively, the urethane (meth)acrylate compound may be the product of reaction between a hydroxyl-containing (meth)acrylate, a polyfunctional isocyanate compound, and a polyol compound. Of these, it is particularly preferred to use a urethane (meth)acrylate compound that is the product of reaction between a hydroxyl-containing (meth)acrylate compound and a polyfunctional isocyanate compound because it leads to good releasability after irradiation with active energy radiation.

Examples of hydroxyl-containing (meth)acrylates include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-(meth)acryloyloxyethyl-2-hydroxypropyl phthalate, 2-hydroxy-3-(meth)acryloyloxypropyl (meth)acrylate, caprolactone-modified 2-hydroxyethyl (meth)acrylate, pentaerythritol tri(meth)acrylate, dipentaerythritol penta(meth)acrylate, dipentaerythritol hexa(meth)acrylate, caprolactone-modified dipentaerythritol penta(meth)acrylate, caprolactone-modified pentaerythritol tri(meth)acrylate, caprolactone-modified pentaerythritol tetra(meth)acrylate, caprolactone-modified dipentaerythritol hexa(meth)acrylate, ethoxylated pentaerythritol tri(meth)acrylate, ethoxylated dipentaerythritol penta(meth)acrylate, and ethoxylated dipentaerythritol hexa(meth)acrylate.

Of these, hydroxyl-containing (meth)acrylates having three or more acryloyl groups are particularly preferred for use, specifically dipentaerythritol penta(meth)acrylate and dipentaerythritol hexa(meth)acrylate. One such (meth)acrylate alone or two or more in combination can be used.

Examples of polyfunctional isocyanate compounds include aromatic polyfunctional isocyanates, such as tolylene diisocyanate, diphenylmethane diisocyanate, polyphenylmethane polyisocyanate, modified diphenylmethane diisocyanate, xylylene diisocyanate, tetramethylxylylene diisocyanate, phenylene diisocyanate, and naphthalene diisocyanate; aliphatic polyisocyanates, such as hexamethylene diisocyanate, trimethylhexamethylene diisocyanate, lysine diisocyanate, and lysine triisocyanate; alicyclic polyfunctional isocyanates, such as hydrogenated diphenylmethane diisocyanate, hydrogenated xylylene diisocyanate, isophorone diisocyanate, and norbornene diisocyanate; and isocyanurates or multimers of such polyfunctional isocyanates, allophanates of polyisocyanates, biurets of polyisocyanates, and water-dispersible polyisocyanates. Of these, aliphatic diisocyanates, such as hexamethylene diisocyanate, trimethylhexamethylene diisocyanate, and lysine diisocyanate, and alicyclic diisocyanates, such as hydrogenated diphenylmethane diisocyanate, hydrogenated xylylene diisocyanate, isophorone diisocyanate, and norbornene diisocyanate, are particularly preferred for reactivity reasons.

Examples of polyol compounds include polyhydric alcohols, such as ethylene glycol, diethylene glycol, triethylene glycol, tetraethylene glycol, polyethylene glycol, propylene glycol, dipropylene glycol, polypropylene glycol, butylene glycol, polybutylene glycol, 1,6-hexanediol, neopentyl glycol, cyclohexanedimethanol, hydrogenated bisphenol A, polycaprolactone, trimethylolethane, trimethylolpropane, polytrimethylolpropane, pentaerythritol, polypentaerythritol, sorbitol, mannitol, glycerol, polyglycerol, and polytetramethylene glycol; polyether polyols having at least one of the structures of polyethylene oxide, polypropylene oxide, and ethylene oxide/propylene oxide block or random copolymerization; polyester polyols that are the products of condensation between such a polyhydric alcohol or polyether polyol and a polybasic acid, such as maleic anhydride, maleic acid, fumaric acid, itaconic anhydride, itaconic acid, adipic acid, or isophthalic acid; caprolactone-modified polyols, such as caprolactone-modified polytetramethylene polyol; polyolefin polyols; polybutadiene polyols, such as hydrogenated polybutadiene polyol; and carboxyl-containing polyols, such as 2,2-bis(hydroxymethyl)butyric acid, tartaric acid, 2,4-dihydroxybenzoic acid, 3,5-dihydroxybenzoic acid, 2,2-bis(hydroxymethyl)propionic acid, 2,2-bis(hydroxyethyl)propionic acid, 2,2-bis(hydroxypropyl)propionic acid, dihydroxymethylacetic acid, bis(4-hydroxyphenyl)acetic acid, 4,4-bis(4-hydroxyphenyl)pentanoic acid, and homogentisic acid, and sulfonic acid- or sulfonate-containing polyols, such as sodium 1,4-butanediol sulfonate.

It is not critical how the urethane (meth)acrylate compound is produced; known methods can be used. For example, it can be produced by mixing a hydroxyl-containing (meth)acrylate, a polyfunctional isocyanate compound, and optionally a polyol compound together in an inert gas atmosphere and inducing urethane formation through known reactions. If a polyol compound is used, a polyfunctional isocyanate and the polyol compound may be allowed to react first, and then a hydroxyl-containing (meth)acrylate may be allowed to react.

The weight-average molecular weight of the urethane (meth)acrylate compound may be in the range of 500 to 10000, in the range of 750 to 5000, or in the range of 1000 to 4000. This makes the (meth)acrylate compound superior in miscibility with the PSA resin, especially with acrylic resins if the PSA resin is an acrylic copolymer, prevents the (meth)acrylate compound from bleeding out of the PSA layer, and helps limit surface contamination of the resin film, for example by adhesive residue, when the PSA film is peeled off after irradiation with active energy radiation.

The amount of the urethane (meth)acrylate compound in the PSA composition can be in the range of 5 to 100 parts by weight, may be in the range of 10 to 90 parts by weight in particular, or in the range of 12 to80 parts by weight per 100 parts by weight of the PSA resin. Making the amount of the urethane (meth)acrylate compound in the PSA composition within these ranges helps make the PSA layer superior in releasability after irradiation with active energy radiation.

### Ethylenically Unsaturated Compound(s)

An ethylenically unsaturated compound is a compound having two or more ethylenically unsaturated groups in one molecule of it. The number of ethylenically unsaturated groups in the ethylenically unsaturated compound only needs to be 2 or greater, may be from 2 to 10, from 3 to 9, or from 4 to 8. Making the number of ethylenically unsaturated groups within these ranges ensures the PSA layer irradiated with active energy radiation will easily peel off the resin film, leaving no adhesive.

The ethylenically unsaturated compound can be any compound having ethylenically unsaturated groups, but may be a (meth)acrylate compound. Examples of ethylenically unsaturated (meth)acrylate compounds include compounds having two ethylenically unsaturated groups, such as ethylene glycol di(meth)acrylate, diethylene glycol di(meth)acrylate, tetraethylene glycol di(meth)acrylate, polyethylene glycol di(meth)acrylate, propylene glycol di(meth)acrylate, dipropylene glycol di(meth)acrylate, polypropylene glycol di(meth)acrylate, butylene glycol di(meth)acrylate, neopentyl glycol di(meth)acrylate, ethoxylated bisphenol A di(meth)acrylate, propoxylated bisphenol A di(meth)acrylate, cyclohexanedimethanol di(meth)acrylate, ethoxylated cyclohexanedimethanol di(meth)acrylate, dimethyloldicyclopentane di(meth)acrylate, tricyclodecanedimethanol di(meth)acrylate, 1,6-hexanediol di(meth)acrylate, glycerol di(meth)acrylate, pentaerythritol di(meth)acrylate, ethylene glycol diglycidyl ether di(meth)acrylate, diethylene glycol diglycidyl ether di(meth)acrylate, diglycidyl phthalate di(meth)acrylate, hydroxypivalic acid-modified neopentyl glycol di(meth)acrylate, and isocyanuric acid ethoxylated diacrylate; compounds having three ethylenically unsaturated groups, such as trimethylolpropane tri(meth)acrylate, pentaerythritol tri(meth)acrylate, tri(meth)acryloyloxyethoxytrimethylolpropane, isocyanuric acid ethoxylated triacrylate, caprolactone-modified pentaerythritol tri(meth)acrylate, ethoxylated pentaerythritol tri(meth)acrylate, and ethoxylated glycerol triacrylate; and compounds having four or more ethylenically unsaturated groups, such as pentaerythritol tetra(meth)acrylate, dipentaerythritol penta(meth)acrylate, dipentaerythritol hexa(meth)acrylate, glycerol polyglycidyl ether poly(meth)acrylate, caprolactone-modified dipentaerythritol penta(meth)acrylate, caprolactone-modified dipentaerythritol hexa(meth)acrylate, caprolactone-modified pentaerythritol tetra(meth)acrylate, ethoxylated dipentaerythritol penta(meth)acrylate, ethoxylated dipentaerythritol hexa(meth)acrylate, and ethoxylated pentaerythritol tetra(meth)acrylate.

Besides these, compounds like Michael adducts of (meth)acrylic acid, such as the (meth)acrylic acid dimer, the (meth)acrylic acid trimer, and the (meth)acrylic acid tetramer; and 2-(meth)acryloyloxyethyl dicarboxylate monoesters, such as the 2-(meth)acryloyloxyethyl succinate monoester, 2-(meth)acryloyloxyethyl phthalate monoester, and 2-(meth)acryloyloxyethyl hexahydrophthalate monoester, are also examples of ethylenically unsaturated (meth)acrylate compounds that can be used.

One such ethylenically unsaturated compound may be used alone, or two or more may be used in combination.

The amount of the ethylenically unsaturated compound(s) in the PSA composition may be 5 parts by weight or more and 100 parts by weight or less, 10 parts by weight or more and 80 parts by weight or less, or 20 parts by weight or more and 60 parts by weight or less per 100 parts by weight of the PSA resin. Making the amount of the ethylenically unsaturated compound(s) in the PSA composition within these ranges helps make the PSA layer superior in releasability after irradiation with active energy radiation and in contamination resistance.

### Crosslinking Agent(s)

The PSA composition may contain a crosslinking agent so that the loss tangent of the PSA layer in a predetermined temperature range will be adjusted into a predetermined range and that the resulting PSA layer will have high cohesiveness. Examples of crosslinking agents include isocyanate crosslinking agents, epoxy crosslinking agents, metal chelate crosslinking agents, aziridine crosslinking agents, oxazoline crosslinking agents, melamine crosslinking agents, aldehyde crosslinking agents, and amine crosslinking agents. One such crosslinking agent may be used alone, or two or more may be used in combination. Of these, it is more preferred to use an isocyanate crosslinking agent and/or an epoxy crosslinking agent, for reasons such as reactivity with the PSA resin and the active energy radiation-curable compound(s) and firm adhesion to the base material.

The isocyanate crosslinking agent can be a known material. Examples include 2,4-tolylene diisocyanate, 2,6-tolylene diisocyanate, hydrogenated tolylene diisocyanate, hydrogenated xylene diisocyanate, hexamethylene diisocyanate, diphenylmethane-4,4-diisocyanate, isophorone diisocyanate, 1,3-bis (isocyanatomethyl)cyclohexane, tetramethylxylylene diisocyanate, 1,5-naphthalene diisocyanate, and triphenylmethane triisocyanate, adducts of such polyisocyanate compounds and polyol compounds, such as trimethylolpropane, and the biurets and isocyanurates of such polyisocyanate compounds.

The epoxy crosslinking agent can be a known material. Examples include bisphenol A-epichlorohydrin epoxy resins, ethylene glycol diglycidyl ether, polyethylene glycol diglycidyl ether, glycerol diglycidyl ether, glycerol triglycidyl ether, 1,6- hexanediol diglycidyl ether, trimethylolpropane triglycidyl ether, sorbitol polyglycidyl ether, polyglycerol polyglycidyl ether, pentaerythritol polyglycidyl ether, diglycerol polyglycidyl ether, 1,3′-bis(N,N-diglycidylaminomethyl)cyclohexane, and N,N,N′,N′-tetraglycidyl-m-xylenediamine.

The crosslinking agent content of the PSA composition can be selected so that the tanδ of the PSA layer and the PSA composition will fall within the ranges specified above.

### Other Ingredients

Besides the ingredients described above, the PSA composition may contain a photopolymerization initiator. The photopolymerization initiator only needs to be a compound that creates radicals in response to irradiation with active energy radiation, and can be a known photopolymerization initiator, such as an acetophenone, benzoin, benzophenone, thioxanthone, or acylphosphine oxide compound. One such initiator may be used alone, or two or more may be used in combination. The photopolymerization initiator content of the PSA composition is not critical; it can be selected so that the curing of the PSA composition will proceed to a sufficient extent in response to irradiation with active energy radiation. For example, it can be 0.1 parts by weight or more and 20 parts by weight or less per 100 parts by weight of the PSA resin and the active energy radiation-curable compound(s) combined.

To give a PSA layer better in peel adhesion, furthermore, the PSA composition may contain a tackifying resin besides the above ingredients. Examples of tackifying resins that can be used include rosin tackifying resins, polymerized rosin tackifying resins, polymerized rosin ester tackifying resins, rosin phenolic tackifying resins, stabilized rosin ester tackifying resins, disproportionated rosin ester tackifying resins, hydrogenated rosin ester tackifying resins, terpene tackifying resins, terpene phenolic tackifying resins, petroleum resin-based tackifying resins, and (meth)acrylate resin-based tackifying resins. One such resin may be used alone, or two or more may be used in combination.

The PSA composition, furthermore, may contain additives besides the above ingredients, including coloring agents, such as pigments and dyes, antidegradants, antistatic agents, flame retardants, silicone compounds, chain transfer agents, plasticizers, softening agents, fillers, such as glass or plastic fibers/balloons, beads, metals, metal oxides, and metal nitrides, leveling agents, thickening agents, water-repellent agents, and defoamers.

### PSA Layer

The thickness of the PSA layer in one or more embodiments may be 200 µm or less, 1 µm or more and 150 µm or less, or 5 µm or more and 100 µm or less. With a thickness in these ranges, the PSA layer is highly adhesive to the resin film until it is irradiated with active energy radiation, and is permeable to active energy radiation enough to undergo curing reaction.

### Base Material

The base material in one or more embodiments is an element that supports the PSA layer. The base material may be strong enough to transport or protect the resin film and resistant to heat enough to withstand the temperature conditions of the annealing of the resin film. The base material may have characteristics suitable for the processing the resin film will undergo according to its purpose of use, such as superior shaping stability when the resin film is shaped into a different shape.

The base material may be permeable to active energy radiation or may be impermeable to active energy radiation, but may be permeable to active energy radiation because in that case the PSA layer can be irradiated with active energy radiation for the removal of the PSA film through the base material. The total transmittance of the base material is not critical as long as the base material is sufficiently permeable to active energy radiation, but may be 80% or higher, 85% or higher, 90% or higher, in particular 95% or higher.

Examples of base materials include a resin film, metal foil, paper, textile, and nonwoven fabric. Of these, a resin film is particularly preferred for handling and active energy radiation permeability reasons.

Examples of resin films include polyester resin films, such as a polyethylene terephthalate film, a polybutylene terephthalate film, and a polyethylene naphthalate film; polyolefin resin films, for example of polyethylene, polypropylene, and polymethylpentene; cyclic olefin resin films, for example of cycloolefin polymers and polymers having a norbornene structure; fluoropolymer films, for example of polyvinyl fluoride, polyvinylidene fluoride, and polyethylene fluoride; polyamide resin films, for example of nylon 6 and nylon 6,6; polyimide resin films, for example of polyetherimide; vinyl polymer resin films, for example of polyvinyl chloride, polyvinylidene chloride, polyvinyl chloride/vinyl acetate copolymers, ethylene-vinyl acetate copolymers, ethylene-vinyl alcohol copolymers, polyvinyl alcohol, and vinylon; cellulose resin films, for example of diacetyl cellulose, triacetyl cellulose, acetyl cellulose butyrate, and cellophane; acrylic resin films, for example of polymethyl methacrylate, polyethyl methacrylate, polyethyl acrylate, and polybutyl acrylate; sulfone resin films, such as a polysulfone film and a polyethersulfone film; polystyrene resin films; polycarbonate resin films; and a polymethylpentene film and a polyether ether ketone film. Of these, polyester resin films, acrylic resin films, and polycarbonate resin films are particularly preferred because they combine suitability for thermal shaping with an appropriate degree of tensile strength that allows the shaped film to be peeled off without breaking. It is more preferred to use a polyethylene terephthalate film.

The base material may have a single-layer structure, in which the base material is one single layer, or may have a multilayer structure, which is a stack of two or more layers. If the base material is a stack of two or more layers, the layers may be the same or may be different.

The base material may have a highly adhesive layer on its surface for improved adhesion to the PSA layer or may have a treated surface for the same purpose. Examples of surface treatments include surface texturing, for example by sandblasting or solvent treatment, and oxidizing treatments, such as corona discharge treatment, chromate conversion coating, flame treatment, hot-air treatment, ozonation, and ultraviolet irradiation.

When a resin film is subjected to a thermal shaping process, such as forming, bending, or three-dimensional shaping, attaching the PSA film according to one or more embodiments to the resin film and shaping the resin and PSA films together in that state helps protect the surface of the resin film during the shaping process.

The stress in the base material at 100% elongation at 150° C. is not critical and can be selected according to the characteristics the PSA film needs to have, but for the ease of shaping of the PSA film, the stress at 100% elongation at 150° C. may be 5 MPa or more and 60 MPa or less, 10 MPa or more and 50 MPa or less, 15 MPa or more and 45 MPa or less, or 15 MPa or more and 40 MPa or less. If the stress in it at 100% elongation at 150° C. is in these ranges, the base material is superior in shaping stability when a resin film is thermoformed with the PSA film attached to it; in that case the PSA film is highly conformable to the changed shape, and this helps prevent shaping defects, such as wrinkles.

The elongation at break of the base material at 150° C. is not critical and can be selected according to the characteristics the PSA film needs to have, but for the ease of shaping of the PSA film, the elongation at break at 150° C. may be 500% or less, 100% or more and 400% or less, 120% or more and 300% or less, in particular 120% or more and 250% or less. When a resin film is thermoformed with the PSA film attached to it, this ensures the PSA film is highly conformable to the changed shape of the resin film and helps prevent the base material from being deformed or broken by the applied heat.

The stress in the base material at 100% elongation at 150° C. and the elongation at break of the base material at 150° C. can each be measured as follows. First, the base material is cut into a rectangle measuring 150 mm long and 10 mm wide for use as a sample, and this sample is subjected to a tensile test using a tensile tester (A&D Co., Ltd.’s TENSILON RTG-1310), with the initial distance between the tensile chucks set to 50 mm and the tensile speed set to 200 mm/min. The sample is placed in a thermostatic chamber preset to 150° C., preheated for 90 seconds, and then subjected to the tensile test. The load on the sample at 100% elongation (when the distance between the chucks reaches 100 mm) is read, and the reading divided by the cross-sectional area of the sample before the test (thickness of the base material ×x 10 mm) is reported as the stress at 100% elongation. The elongation of the sample when it breaks during the same measurement is reported as the elongation at break. The stress and the elongation are measured five times each, and the averages are used for evaluation.

The percentage thermal shrinkage at 150° C. of the base material may be 25% or lower, 15% or lower, or 5% or lower. Making the percentage thermal shrinkage of the base material in these ranges ensures the base material will not easily shrink at the temperature of the annealing conditions when a resin film is annealed with the PSA film attached to it, helping prevent the PSA film from peeling off the resin film before irradiation with active energy radiation. Such a percentage thermal shrinkage of the base material also helps prevent the removal and relief of residual stress and strain, respectively, in the resin film from being interfered with by the thermal shrinkage of the base material.

The percentage thermal shrinkage of the base material at 150° C. is measured as follows. First, a square with outer dimensions of 120 mm by 120 mm cut out of the base material is marked in its longitudinal and transverse directions for the measurement of gauge lengths (L₀ and T₀), and the gauge lengths are measured. Then the base material is left at 150° C. for 30 minutes, and the longitudinal and transverse gauge lengths (L and T) are measured once again at 23° C. and 50% RH. The percentage thermal shrinkage is calculated according to the following equations.

$$\begin{matrix}\text{Longitudinal percentage thermal shrinkage =} \left[\left({\text{L}}_{0} - \text{L}\right) / {\text{L}}_{0}\right] \\ \times 100 \left(\text{unit, \%}\right)\end{matrix}$$

$$\begin{matrix}\text{Transverse percentage thermal shrinkage =} \left[\left({\text{T}}_{0} - \text{T}\right) / {\text{T}}_{0}\right] \times \\ 100 \left(\text{unit, \%}\right)\end{matrix}$$

(L₀ and T₀, gauge lengths before the heating (mm);
L and T, gauge lengths after the heating (mm))

The thickness of the base material is not critical, but may be 12 µm or more and 250 µm or less, 25 µm or more and 100 µm or less, or 38 µm or more and 75 µm or less. Making the thickness of the base material in these ranges helps ensure the adherend will not come off easily but be highly conformable under high-temperature conditions, for example of annealing, and will be highly releasable after irradiation with active energy radiation.

### Release Liner

The PSA film according to one or more embodiments may have a release liner on the side of the PSA layer opposite the base material. The release liner can be of any kind, but an example is one formed by a base material, which can be, for example, a resin film, such as a polyethylene, polypropylene, or polyester film, paper, nonwoven fabric, cloth, a foam sheet, metal foil, or a laminate of such materials, and a release treatment for improved release from the PSA on at least one side of the base material, such as silicone, long-chain alkyl, or fluorine treatment.

### PSA Film

The PSA film according to one or more embodiments only needs to have a PSA layer on at least one side of the base material; it may be a single-sided PSA film, which has a PSA layer on one side of the base material, or may be a double-sided PSA film, which has a PSA layer on both sides of the base material. Of these, the PSA film may be a single-sided one, having a PSA layer on one side of the base material, because in that case the PSA film functions as, for example, a process film or protective film.

If being a double-sided PSA film, the PSA film according to one or more embodiments only needs to have a PSA layer having a predetermined tanδ on at least one side of the base material; it may have a PSA layer having a predetermined tanδ on both sides of the base material.

The thickness of the PSA film according to one or more embodiments is not critical, but may be appropriate for the film to be consistently workable in annealing and thermoforming processes. Specifically, the total thickness of the PSA film according to one or more embodiments may be 200 µm or less, or 175 µm or less. There is no particular lower limit, but the total thickness of the PSA film according to one or more embodiments may be 40 µm or more, or 50 µm or more. It should be noted that the total thickness of the PSA film does not include the thickness of the release liner described above.

The PSA film according to one or more embodiments and the individual layers forming it, i.e., the PSA layer(s) and the base material, may be transparent to be sufficiently permeable to active energy radiation. If the PSA film is attached to a transparent resin film and if the PSA film can be irradiated with active energy radiation from the resin film side, however, the base material of the PSA film may be transparent or may be nontransparent.

### Production of the PSA Film

The PSA film according to one or more embodiments can be produced by, for example, applying the PSA composition for the formation of the PSA layer(s) to at least one side of the base material, for example using an applicator, roller coater, gravure coater, reverse-roll coater, spray coater, air-knife coater, or slot-die coater, and drying the coating(s).

Alternatively, the PSA film according to one or more embodiments can be produced by transfer, in which the PSA composition is applied to the surface of a release liner as described above, for example using a knife coater, roller coater, or slot-die coater, the coating is dried to form a PSA layer, and then the PSA layer is attached to at least one side of the base material.

Before the application of the PSA composition, the viscosity of the PSA composition is adjusted by dissolving or dispersing the composition in an organic solvent so that the composition will be easy to handle, for example, while being applied. The solvent can be, for example, toluene, xylene, ethyl acetate, butyl acetate, acetone, methyl ethyl ketone, or hexane. If a water-borne PSA is made, the solvent can be water or an aqueous solvent that is primarily water.

The PSA layer(s) may be formed by drying the coating(s) of the PSA composition at 50° C. to 140° C. for 30 seconds to 10 minutes. The dried coating(s) of the PSA composition may be further aged in the range of 30° C. to 50° C. for accelerated curing reaction.

### Applications

The PSA film according to one or more embodiments is suitable for use as a process film for temporarily securing and transporting a resin film or as a surface protection film for protecting the surface of a resin film. Although resin films usually need annealing, the PSA film according to one or more embodiments can also be used to transport or protect the surface of resin films that require no annealing.

The resin that forms the resin film is not critical and can be selected according to the purpose of use and function of the resin film. Examples include resins such as polyethylene terephthalate (PET), polyethylene naphthalate, and other polyester resins, polyolefin resins like polyethylene (PE), polypropylene (PP), polybutene-1, poly-4-methylpentene, and ethylene-propylene copolymers, acrylic resins, polycarbonates, polyamides, polyimides, triacetylcellulose (TAC), and cycloolefin polymers. The resin film may be an unannealed one if it is used as a component of a laminate, but the resin film may be an annealed one.

The glass transition temperature of the resin film is not critical as long as it permits the film to be annealed in the temperature range specified below and can be selected according to the resin used. The other characteristics of the resin film are not critical either and can be selected according to the resin used.

Examples of resin films include industrial films for use as components of displays, components of electronics, automotive components, etc. The resin film may be an optical film because in that case the resin film can be annealed to achieve high dimensional accuracy and high optical performance, which are requirements for optical films, while being transported by the PSA film attached to it or with its surface protected by the PSA film. Examples of optical films include polarizing films, retarder films, anti-reflection films, anti-glare films, ultraviolet-absorbing films, infrared-absorbing films, optical compensation films, brightness enhancement films, diffusers, and prismatic sheets.

The PSA film according to one or more embodiments is suitable for use as a process film or surface protection film to be attached to a resin film as stated above, but these are not the only applications of it; it can also be used as a process film or surface protection film for materials other than resin films.

### Method for Using the PSA Film

An example of a method for using the PSA film according to one or more embodiments is a method for using a PSA film including the following steps in the indicated order: a step of attaching a resin film to the PSA layer of the PSA film according to one or more embodiments to obtain a laminate; a step of annealing the resin film of the laminate; and a step of irradiating the laminate after the annealing step with active energy radiation to peel the PSA film off the resin film.

In making the laminate, the resin film may be attached directly to the PSA layer.

The conditions of the annealing of the resin film can be selected according to the resin film used and the material forming it, but the temperature can be 70° C. or above. The temperature may be 70° C. or above and 350° C. or below, 70° C. or above and 150° C. or below, or 70° C. or above and 100° C. or below. The duration of annealing is not critical as long as the strain in the resin film is relieved, but can be 5 minutes or more and 1 hour or less. The duration of annealing may be 10 minutes or more and 40 minutes or less.

In irradiating the laminate, formed by attaching a resin film to the PSA layer of the PSA film, with active energy radiation, the resin film side of the laminate may be irradiated, or the side opposite the resin film may be irradiated.

The irradiation parameters in the irradiation with active energy radiation, furthermore, can be selected according to, for example, the chemical makeup of the PSA layer, but the irradiance may be 50 mW/cm² or more and 2000 mW/cm² or less, and the exposure is 50 mJ/cm² or more and 3000 mJ/cm² or less. The light source can be selected according to the active energy radiation used.

### 2. Laminate

A laminate according to one or more embodiments of the present invention has a PSA film as described in “1. PSA Film″ and a resin film on the PSA layer of the PSA film.

FIG. 2 is a schematic cross-sectional diagram illustrating an example of a laminate according to one or more embodiments of the present invention, in which there is a resin film 11 on a PSA layer 2 of a PSA film 10. As a component of the laminate, the resin film is directly on the PSA layer (has been attached to the PSA layer) of the PSA film.

As a component of the laminate according to one or more embodiments, the PSA film, attached to the resin film, has a PSA layer having a temperature region, within the range of 70° C. to 100° C., in which its loss tangent tanδ is 0.8 or greater, and can be peeled off through irradiation with active energy radiation. The laminate, therefore, can be subjected directly to the annealing of the resin film and also provides a way of surface protection and the transport of the resin film.

The details of the PSA film as a component of the laminate according to one or more embodiments are not described; they are the same as described in “1. PSA Film.” The resin film as a component of the laminate according to one or more embodiments, furthermore, can be a resin film as described in “1. PSA Film.” The resin film may be an optical film because it requires high dimensional accuracy.

### 3. Method for Producing an Optical Film

A method according to one or more embodiments of the present invention for producing an optical film is a production method including the following steps in the indicated order: a step of obtaining a laminate having a PSA film and an optical film, the PSA film including a base material and a PSA layer on one side of the base material and the optical film being on the PSA layer of the PSA film; a step of annealing the optical film of the laminate; and a step of irradiating the laminate after the annealing step with active energy radiation to peel the optical film off the PSA film. The PSA layer has a temperature region, within the range of 70° C. to 100° C., in which its loss tangent tanδ is 0.8 or greater.

The PSA film in this method for producing an optical film can be a PSA film as described in “1. PSA Film.” The details of the optical and PSA films, the parameters of annealing conditions, and the side of the PSA film irradiated with active energy radiation and the irradiation parameters in this method for producing an optical film can be the same as already described in “1. PSA Film.”

No aspect of one or more embodiments of the present invention is limited to the above embodiments. The above embodiments are provided by way of example, and anything having substantially the same configuration as and offering advantages similar to those of a technical idea described in the claims of one or more embodiments of the present invention is encompassed in the technical scope of one or more embodiments of the present invention.

### EXAMPLES

Aspects of one or more embodiments of the present invention will now be more specifically described by examples and comparative examples. The longitudinal and transverse percentage thermal shrinkages of the polyethylene terephthalate films used in the examples and comparative examples were measured at 150° C. according to the method described in “1. PSA Film.” The stress at 100% elongation and the elongation at break were measured at 150° C. according to the methods descried in “1. PSA Film.”

### Preparation Example 1

A reactor equipped with a stirrer, a reflux condenser, a nitrogen inlet tube, and a thermometer was loaded with 100 parts by weight of ethyl acetate, 10 parts by weight of toluene, and 0.03 parts by weight of azobisisobutyronitrile (AIBN), and the materials were refluxed at an elevated temperature of 95° C. while being stirred. A monomer premix was separately prepared by mixing 100 parts by weight of n-butyl acrylate, 38 parts by weight of methyl methacrylate, and 3.8 parts by weight of methacrylic acid together, and all of this monomer premix was added dropwise over 2 hours. At 1 hour after the end of the addition, 0.03 parts by weight of azobisisobutyronitrile (AIBN) and 4 parts by weight of toluene were added. The mixture was allowed to react for 2 hours and filtered through a 200-mesh metal sieve. This gave a solution of acrylic copolymer (A-1), a copolymer having a weight-average molecular weight of 380,000 (nonvolatile content, 50% by mass).

### Preparation Example 2

A reactor equipped with a stirrer, a reflux condenser, a nitrogen inlet tube, and a thermometer was loaded with 146 parts by weight of ethyl acetate, 15 parts by weight of toluene, and 0.04 parts by weight of azobisisobutyronitrile (AIBN), and the materials were refluxed at an elevated temperature of 95° C. while being stirred. A monomer premix was separately prepared by mixing 100 parts by weight of methyl methacrylate and 61 parts by weight of 2-ethylhexyl acrylate together, and all of this monomer premix was added dropwise over 2 hours. At 1 hour after the end of the addition, 0.04 parts by weight of azobisisobutyronitrile (AIBN) and 6 parts by weight of toluene were added. The mixture was allowed to react for 2 hours and filtered through a 200-mesh metal sieve. This gave a solution of acrylic copolymer (A-2), a copolymer having a weight-average molecular weight of 250,000 (nonvolatile content, 50% by mass).

### Comparative Preparation Example 1

A reactor equipped with a stirrer, a reflux condenser, a nitrogen inlet tube, and a thermometer was loaded with 146 parts by weight of ethyl acetate, 15 parts by weight of toluene, and 0.04 parts by weight of azobisisobutyronitrile (AIBN), and the materials were refluxed at an elevated temperature of 95° C. while being stirred. A monomer premix was separately prepared by mixing 100 parts by weight of methyl methacrylate and 61 parts by weight of 2-ethylhexyl acrylate together, and all of this monomer premix was added dropwise over 2 hours. At 1 hour after the end of the addition, 0.04 parts by weight of azobisisobutyronitrile (AIBN) and 6 parts by weight of toluene were added. The mixture was allowed to react for 2 hours and filtered through a 200-mesh metal sieve. This gave a solution of acrylic copolymer (B-1), a copolymer having a weight-average molecular weight of 250,000 (nonvolatile content, 50% by mass).

### Comparative Preparation Example 2

A reactor equipped with a stirrer, a reflux condenser, a nitrogen inlet tube, and a thermometer was loaded with 138 parts by weight of ethyl acetate, 14 parts by weight of toluene, and 0.04 parts by weight of azobisisobutyronitrile (AIBN), and the materials were refluxed at an elevated temperature of 95° C. while being stirred. A monomer premix was separately prepared by mixing 100 parts by weight of n-butyl acrylate and 52 parts by weight of methyl acrylate together, and all of this monomer premix was added dropwise over 2 hours. At 1 hour after the end of the addition, 0.04 parts by weight of azobisisobutyronitrile (AIBN) and 6 parts by weight of toluene were added. The mixture was allowed to react for 2 hours and filtered through a 200-mesh metal sieve. This gave a solution of acrylic copolymer (B-2), a copolymer having a weight-average molecular weight of 150,000 (nonvolatile content, 50% by mass).

### Comparative Preparation Example 3

A reactor equipped with a stirrer, a reflux condenser, a nitrogen inlet tube, and a thermometer was loaded with 82 parts by weight of 2-ethylhexyl acrylate, 14 parts by weight of methyl acrylate, 4 parts by weight of 2-hydroxyethyl acrylate, and 200 parts by weight of ethyl acetate. The materials were stirred at 72° C. for 4 hours and then at 75° C. for 5 hours. Then an ethyl acetate solution of 2 parts by weight of azobisisobutyronitrile (AIBN) (solids content, 0.1% by mass) prepared beforehand was added to the mixture, and the resulting mixture was stirred at 72° C. for 4 hours and then at 75° C. for 5 hours. Then the resulting mixture was mixed with ethyl acetate until homogeneity, and the resulting mixture was filtered through a 200-mesh metal sieve. This gave a solution of acrylic copolymer (B-3), a copolymer having a weight-average molecular weight of 880,000 (nonvolatile content, 34% by mass).

### Synthesis of an Active Energy Radiation-Curable Compound (C)

A reactor equipped with a stirrer, a reflux condenser, a nitrogen inlet tube, and a thermometer was charged with 7.1 parts by weight of isophorone diisocyanate, 100 parts by weight of a mixture of dipentaerythritol pentaacrylate and dipentaerythritol hexaacrylate (hydroxyl value, 48 mg KOH/g), 0.06 parts by weight of 2,6-di-tert-butylcresol as a polymerization inhibitor, and 0.02 parts by weight of dibutyltin laurate as a reaction catalyst. The materials were allowed to react at 60° C., and the reaction was terminated when the percentage of residual isocyanate groups was 0.3% or less. This gave an ethylenically unsaturated compound (urethane (meth)acrylate) as an active energy radiation-curable compound. The number of unsaturated groups in the resulting ethylenically unsaturated compound was ten per molecule.

### Example 1

One hundred parts by weight of the solution of acrylic copolymer (A-1), 50 parts by weight of the active energy radiation-curable compound (C), 1 part by weight of 1-hydroxycyclohexyl phenyl ketone (Omnirad 184, IGM Resins B.V.) as a photopolymerization initiator (D), and an adduct of tolylene diisocyanate with trimethylolpropane as a crosslinking agent (E) (DIC Corporation’s “BURNOCK D-40,” hereinafter abbreviated to “D-40”) that would make the gel fraction 25% by mass were put into a light-resistant container fitted with a stirrer. The materials were mixed together by stirring for 2 hours for dissolution, and this gave PSA composition (P-1).

The resulting PSA composition (P-1) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (T-1), a film having a thickness of 125 µm.

### Example 2

PSA composition (P-1), obtained as in the foregoing, was coated onto the release-agent side of a release liner (a 50-µm thick polyethylene terephthalate film treated with a release agent on one side) to the extent that the thickness of the dried PSA layer would be 25 µm. The coating was dried at 85° C. for 5 minutes to give a 25-µm thick PSA layer.

Then, under 23° C. conditions, this 25-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (T-2), a film having a thickness of 100 µm.

### Example 3

PSA composition (P-2) was obtained in the same way as in Example 1, except that the solution of acrylic copolymer (A-1) in Example 1 was changed to the solution of acrylic copolymer (A-2) and that the crosslinking agent (E) was added to make the gel fraction 15% by mass.

The resulting PSA composition (P-2) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (T-3), a film having a thickness of 125 µm.

### Example 4

PSA composition (P-3) was obtained in the same way as in Example 1, except that the crosslinking agent (E) was added to the solution of acrylic copolymer (A-1) in Example 1 to make the gel fraction 35% by mass.

The resulting PSA composition (P-3) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (T-4), a film having a thickness of 125 µm.

### Example 5

PSA composition (P-4) was obtained in the same way as in Example 1, except that the crosslinking agent (E) was added to the solution of acrylic copolymer (A-1) in Example 1 to make the gel fraction 40% by mass.

The resulting PSA composition (P-4) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (T-5), a film having a thickness of 125 µm.

### Example 6

PSA composition (P-1) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 37 MPa; longitudinal elongation at break, 231%), and the top surface of the release liner was pressed with a roller at a linear pressure of 5 kg/cm for lamination.

Then the resulting laminate was aged under 40° C. conditions for 48 hours. This gave PSA film (T-6), a film having a thickness of 125 µm.

### Example 7

PSA composition (P-1) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 50-µm thick polyethylene terephthalate film (longitudinal percentage thermal shrinkage, 0.4%; transverse percentage thermal shrinkage, 0.0%; longitudinal stress at 100% elongation, 70 MPa; longitudinal elongation at break, 266%), and the top surface of the release liner was pressed with a roller at a linear pressure of 5 kg/cm for lamination.

Then the resulting laminate was aged under 40° C. conditions for 48 hours. This gave PSA film (T-7), a film having a thickness of 100 µm.

### Comparative Example 1

PSA composition (Q-1) was obtained in the same way as in Example 1, except that the solution of acrylic copolymer (A-1) in Example 1 was changed to the solution of acrylic copolymer (B-1) and that the crosslinking agent (E) was added to make the gel fraction 30% by mass.

The resulting PSA composition (Q-1) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (U-1), a film having a thickness of 125 µm.

### Comparative Example 2

PSA composition (Q-2) was obtained in the same way as in Example 1, except that the solution of acrylic copolymer (A-1) in Example 1 was changed to the solution of acrylic copolymer (B-2) and that the crosslinking agent (E) was added to make the gel fraction 50% by mass.

The resulting PSA composition (Q-2) was coated onto the release-agent side of a release liner (a 50-µm thick polyethylene terephthalate film treated with a release agent on one side) to the extent that the thickness of the dried PSA layer would be 50 µm. The coating was dried at 85° C. for 5 minutes to give a 50-µm thick PSA layer.

Then, under 23° C. conditions, this 50-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (U-2), a film having a thickness of 125 µm.

### Comparative Example 3

PSA composition (Q-3) was obtained by adding D-40 to the solution of acrylic copolymer (B-3) to make the gel fraction 80% by mass. It should be noted that PSA composition (Q-3) has a chemical makeup with no active energy radiation-curable compound; its adhesion and releasability, therefore, are equivalent between before and after irradiation with active energy radiation.

The resulting PSA composition (Q-3) was coated onto the release-agent side of a release liner (a 50-µm thick polyethylene terephthalate film treated with a release agent on one side) to the extent that the thickness of the dried PSA layer would be 5 µm. The coating was dried at 85° C. for 5 minutes to give a 5-µm thick PSA layer.

Then, under 23° C. conditions, this 5-µm thick PSA layer was attached to one side of a 75-µm thick polyethylene terephthalate film (longitudinal percentage thermal shrinkage, 1.5%; transverse percentage thermal shrinkage, 0.9%; longitudinal stress at 100% elongation, 20 MPa; longitudinal elongation at break, 235%), and the top surface of the release liner was pressed with a roller at a linear pressure of 5 kg/cm for lamination.

Then the resulting laminate was aged under 40° C. conditions for 48 hours. This gave PSA film (U-3), a film having a thickness of 55 µm.

### Comparative Example 4

PSA composition (Q-3) was coated onto the release-agent side of a release liner (a 50-µm thick polyethylene terephthalate film treated with a release agent on one side) to the extent that the thickness of the dried PSA layer would be 5 µm. The coating was dried at 85° C. for 5 minutes to give a 5-µm thick PSA layer.

Then, under 23° C. conditions, this 5-µm thick PSA layer was attached to one side of a 50-µm thick polyethylene terephthalate film (longitudinal percentage thermal shrinkage, 0.4%; transverse percentage thermal shrinkage, 0.0%; longitudinal stress at 100% elongation, 37 MPa; longitudinal elongation at break, 266%), and the top surface of the release liner was pressed with a roller at a linear pressure of 5 kg/cm for lamination.

Then the resulting laminate was aged under 40° C. conditions for 48 hours. This gave PSA film (U-4), a film having a thickness of 55 µm.

### Evaluations

The PSA films obtained in the Examples and Comparative Examples were subjected to the following evaluations. The results of the evaluations are presented in Tables 1 to 3. In the 180° peel adhesion and curl tests, the optical films (resin films) used were optical polyethylene terephthalate films (Toray; product name “LUMIRROR 100U46”; glass transition temperature, 120° C.; thickness, 100 µm). In the thermoforming test, the optical films (resin films) used were optical acrylic resin films (Mitsubishi Chemical; product name “ACRYPLEN HBA007P”; glass transition temperature, 92° C.; thickness, 75 µm).

### Measurement of the Loss Tangent (tanδ) of the PSA Layer

Each of the PSA compositions obtained as in the foregoing was coated onto the surface of release liners. The coatings were heated at 85° C. for 5 minutes using an oven to give 50-µm thick PSA layers, and these PSA layers were stacked to give a 2-mm thick PSA layer. This PSA layer was cut into a 8-mm diameter disk for use as a test specimen. The test specimen was placed between a rheometer’s (Rheometrics; trade name, ARES 2KSTD) parallel plates, which constituted the measuring section of the rheometer, and the storage modulus (G′) and loss modulus (G″) were measured in the temperature range of -40° C. to 150° C. under the conditions of a heating rate of 2.0° C./min and a frequency of 1 Hz in a mode for shear stress measurement. The measured G′ and G″ were used to calculate the loss tangent tanδ. The results are presented in a table below.

### 180° Peel Adhesion of the PSA Films

The 180° peel adhesion of the PSA films of the Examples and Comparative Examples was measured as follows. The results are presented in Tables 2 and 3.
(1) The PSA film was pressed against the optical film at 23° C. and 50% RH to adhere to it by stroking a 2-kg roller back and forth over the PSA film once.
(2) After the laminate was left at 23° C. and 50% RH for 1 hour, the PSA film was peeled off the optical film at an angle of 180° at a tensile speed of 300 mm/min at 23° C. and 50% RH while the strength was measured (unit, N/25 mm).

### Releasability: 180° Peel Adhesion of the PSA Films after Irradiation with Active Energy Radiation

The 180° peel adhesion of the PSA films of the Examples and Comparative Examples after irradiation with active energy radiation was measured as follows. The results are presented in Tables 2 and 3.
(1) The PSA film was pressed against the optical film at 23° C. and 50% RH to adhere to it by stroking a 2-kg roller back and forth over the PSA film once.
(2) After being left at 23° C. and 50% RH for 1 hour, the laminate was annealed by heating at 90° C. for 20 minutes. Then the laminate was irradiated with ultraviolet radiation (integrated exposure, 180 mJ/cm²) from a height of 8 cm at a conveyor speed of 6.5 m/min using Heraeus’s 90-mW electrodeless lamp.
(3) The PSA film was peeled off the optical film at an angle of 180° at a tensile speed of 300 mm/min at 23° C. and 50% RH while the strength was measured (unit, N/25 mm).
(4) Releasability was graded visually. The criteria for grading were as follows.

### Criteria

⊚: The PSA film was able to be peeled off without deforming or breaking the optical film.

◯: The PSA film was able to be peeled off without deforming or breaking the optical film, although resistance was felt.

×: The PSA film was not able to be peeled off, and the optical film broke.

-: No change in characteristics associated with the irradiation with active energy radiation was observed; the PSA composition contained no active energy radiation-curable compound.

The presence of adhesive residue was graded visually. The criteria for grading were as follows.

### Criteria

○: There was no PSA residue.

×: There was PSA residue on the optical film.

-: No change in characteristics associated with the irradiation with active energy radiation was observed; the PSA composition contained no active energy radiation-curable compound.

### Negligibility in the Relief of Residual Stress and Strain In a Resin Film During Annealing: Curl Test

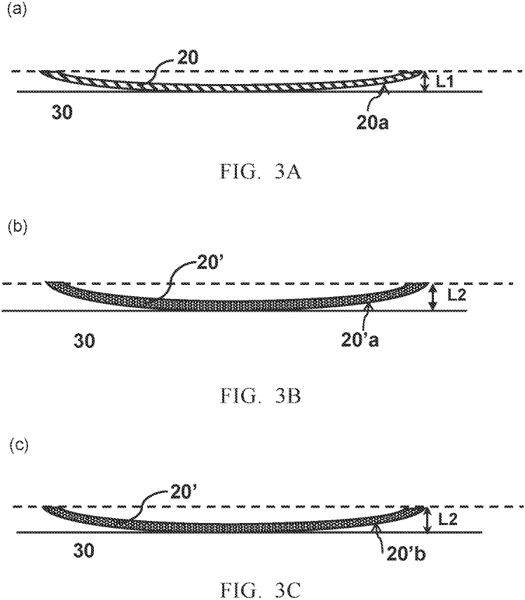

As a way to evaluate negligibility in the relief of residual stress and strain in a resin film during annealing, optical films with the PSA films of the Examples and Comparative Examples attached to them were subjected to the following curl test. FIGS. 3A to 3C are illustrations for the description of the method of the curl test. The results are presented in Tables 2 and 3.
(1) At 23° C. and 50% RH, the PSA layer side of the PSA film was attached to one side of the optical film, and the resulting laminate was cut into a square of 150 mm side to give a sample 20 (laminate 20).
(2) The sample 20 was put on a level surface 30 with the surface 20a on the optical film side down, and the lift (L1) of the sample 20 from the level surface 30 was measured at each of the four corners at 23° C. and 50% RH (see FIG. 3A).
(3) Then the sample 20 was heated in an oven at 90° C. for 20 minutes so that the optical film would be annealed, and then the annealed sample 20′ was left at room temperature until it returned to room temperature.
(4) The annealed sample 20′ was put on the level surface 30 with the surface 20′a on the optical film side down, and the lift (L2) of the sample 20′ from the level surface 30 was measured at each of the four corners at 23° C. and 50% RH (see FIG. 3B). If the annealed sample 20′ was curved with the surface 20′a on the optical film side inside as in FIG. 3C, the sample 20′ was placed with the surface 20′b on the PSA film side on the level surface 30, and the lengths between the level surface 30 and the four corners of the sample 20′ were reported as the lifts (L2) of the sample 20′ with a minus sign.
(5) The lift Δ(L) of the sample at each corner was calculated according to the following equation.
$$\begin{matrix}\text{Lift Δ(L) = Lift after heating (L2) - Lift before} \\ \text{heating (L1)}\end{matrix}$$
In addition to this,
(6) the Δ(L)s at the four corners were averaged, and the average was reported as the lift aveΔ(L) of the adherend. This lift aveΔ(L) of the adherend was used to determine suitability for deformation. The determination of suitability for deformation was based on the following criteria. For the reason described later herein, smaller absolute lifts aveΔ(L) of the adherend indicate greater relief of residual stress and strain in the resin film.

### Criteria

⊚: -5 mm < Lift aveΔ(L) < 5 mm
◯: -9 mm < Lift aveΔ(L) ≤ -5 mm or 5 mm ≤ Lift aveΔ(L) < 9 mm
×: Lift aveΔ (L) ≤ -9 mm or 9 mm ≤ Lift aveΔ(L)

### Shaping Stability: Thermoforming Test

As a way to evaluate conformability to a curved shape of an optical film in thermoforming, optical films with the PSA films of the Examples and Comparative Examples attached to them were subjected to the following thermoforming test. FIG. 4 is an illustration for the description of the method of the thermoforming test. The results are presented in Tables 2 and 3.

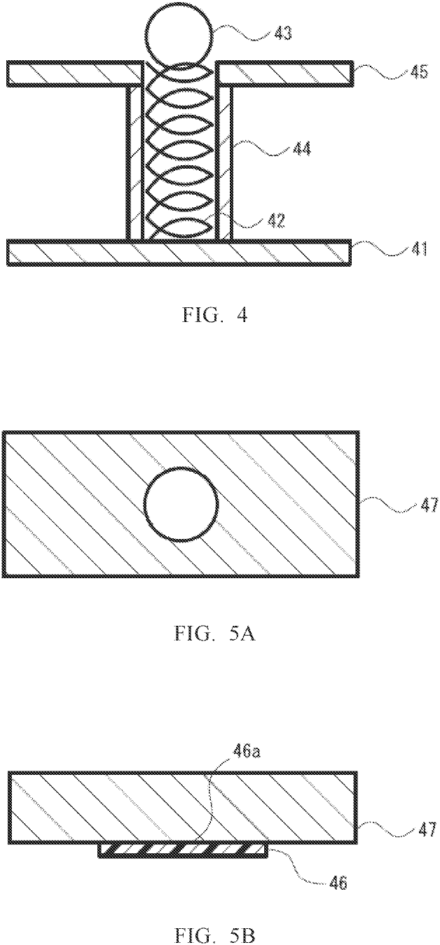

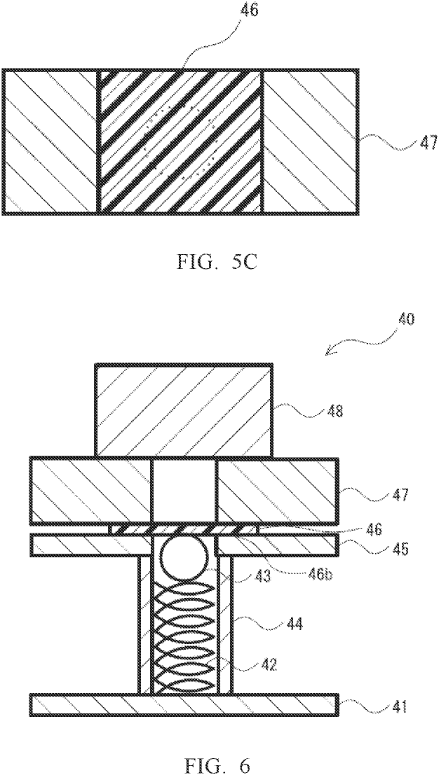

(1) A spring 42 was placed at the center of an 8-mm thick rectangular metal plate 41 measuring 50 mm by 130 mm, and a 20-mm diameter iron ball 43 was situated on the spring 42. A metal cylinder 44 was also placed at the center of the metal plate 41, with the spring 42 inside it. A 4-mm thick rectangular metal plate 45 measuring 50 mm by 130 mm and having a 25-mm diameter hole at its center was put on the cylinder 44 in such a manner that the spring 42 and the iron ball 43 would come out through the hole in the metal plate 45 (see FIG. 4).
(2) The PSA layer side of the PSA film was attached to one side of the optical film, and the resulting laminate was cut into 50 mm by 60 mm to give a sample 46 (laminate 46). The sample 46 was fixed to a 25-mm thick rectangular metal plate 47 measuring 50 mm by 100 mm and having a 25-mm diameter hole at its center, covering the hole at the center of the plate. The fixation of the sample 46 was in such a manner that its optical film surface 46a would be on the metal plate 47. (See FIGS. 5A-5C).
(3) The metal plate 47 with the sample 46 fixed to it was placed on the metal plate 45, with the hole at the center of the metal plate 45 aligned with that of the metal plate 47. Then a 2-kg weight 48 was put on the metal plate 47 so that the metal plate 47 would be immobilized (see FIG. 6). This causes the sample 46 to be stretched into a curved shape as a result of the iron ball 43 pushing the sample 46 at the base material surface 46b of the sample 46. Prior to this, the spring 42 was adjusted so that the iron ball 43 would apply a force of 12 N to the sample 46. The entire test equipment prepared in this step is hereinafter referred to as the test equipment 40.
(4) A thermoforming test was performed by heating the test equipment 40 in an oven at 90° C. for 20 minutes.
(5) The test equipment 40 after the thermoforming test was removed from the oven and left at room temperature until the sample 46 returned to room temperature. The appearance of the sample 46 was observed visually, and shaping stability was graded according to the criteria below. Fewer wrinkles in the sample 46 stretched by thermoforming indicate better shaping stability of the PSA film.

### Criteria

◯: The sample after the test has no wrinkle, or the sample after the test is wrinkled around its stretched and curved portion but with no wrinkle in the stretched and curved portion.

×: The sample after the test is wrinkled in its stretched and curved portion.

TABLE 1

| PSA composition | P-1 | P-2 | P-3 | P-4 | Q-1 | Q-2 | Q-3 |
|---|---|---|---|---|---|---|---|
| Temperatures within the range of 70° C. to 100° C. at which tanδ is 0.8 or greater | 78° C. or above | 70° C. or above (53° C. or above) | 85° C. or above | 90° C. or above | None | None | None |
| tanδ at 90° C. | 0.99 | 1.07 | 0.87 | 0.80 | 0.69 | 0.32 | 0.11 |

TABLE 2

| | | Example 1 | Example 2 | Example 3 | Example 4 | Example 5 | Example 6 | Example 7 |
|---|---|---|---|---|---|---|---|---|
| PSA film | | T-1 | T-2 | T-3 | T-4 | T-5 | T-6 | T-7 |
| PSA layer | PSA composition | P-1 | P-1 | P-2 | P-3 | P-4 | P-1 | P-1 |
| | Thickness [µm] | 50 | 25 | 50 | 50 | 50 | 50 | 50 |
| | Gel fraction [%] | 25 | 25 | 15 | 35 | 40 | 25 | 25 |
| | tanδ at 90° C. | 0.99 | 0.99 | 1.07 | 0.87 | 0.80 | 0.99 | 0.99 |
| Base material layer | Stress at 100% elongation [MPa] | 20 | 20 | 20 | 20 | 20 | 37 | 70 |
| Before irradiation with active energy radiation | 180° peel adhesion [N/25 mm] | 23 | 20 | 15 | 22 | 23 | 23 | 17 |
| After irradiation with active energy radiation | 180° peel adhesion [N/25 mm] | 0.24 | 0.15 | 0.09 | 0.28 | 0.26 | 0.24 | 0.40 |
| | Releasability | ⊚ | ⊚ | ⊚ | ⊚ | ⊚ | ⊚ | ⊚ |
| | Adhesive residue | ◯ | ◯ | ◯ | ◯ | ◯ | ◯ | ◯ |
| Negligibility in the relief of residual stress and strain in a resin film during annealing | Lift aveΔ(L) [mm] in the curl test | 1.8 | 1.6 | -0.1 | 7.3 | 8.0 | 1.8 | -0.6 |
| | Suitability for deformation | ⊚ | ⊚ | ⊚ | ◯ | ◯ | ⊚ | ⊚ |
| Shaping stability | Suitability for working in the thermoforming test | ◯ | ◯ | ◯ | ◯ | ◯ | ◯ | × |

TABLE 3

| | | Comparative Example 1 | Comparative Example 2 | Comparative Example 3 | Comparative Example 4 |
|---|---|---|---|---|---|
| PSA film | | U-1 | U-2 | U-3 | U-4 |
| PSA layer | PSA composition | Q-1 | Q-2 | Q-3 | Q-3 |
| | Thickness [µm] | 50 | 50 | 5 | 5 |
| | Gel fraction [%] | 30 | 50 | 80 | 80 |
| | tanδ at 90° C. | 0.69 | 0.32 | 0.11 | 0.11 |
| Base material layer | Stress at 100% elongation [MPa] | 20 | 20 | 20 | 70 |
| Before irradiation with active energy radiation | 180° peel adhesion [N/25 mm] | 12 | 14 | 1 | 1 |
| After irradiation with active energy radiation | 180° peel adhesion [N/25 mm] | 0.09 | 0.15 | - | - |
| | Releasability | ⊚ | ⊚ | - | - |
| | Adhesive residue | ◯ | ◯ | - | - |
| Negligibility in the relief of residual stress and strain in a resin film during annealing | Lift aveΔ(L) [mm] in the curl test | 12.8 | 18.4 | 22.6 | -9.0 |
| | Suitability for deformation | × | × | × | × |
| Shaping stability | Suitability for working in the thermoforming test | ◯ | ◯ | ◯ | × |

As can be seen from the above results, the PSA films of Examples 1 to 7 reduced the occurrence of curl in the optical film in the curl test, whereas the PSA films of Comparative Examples 1 to 4 allowed the optical film to curl greatly in the curl test. These results indicate PSA films according to an aspect of one or more embodiments of the present invention are unlikely to interfere when a resin film is annealed at a temperature around 100° C. for the relief of residual stress and strain in it.

The relationship between the results of the curl test and negligibility in the relief of residual stress and strain in a resin film during annealing is as follows. Annealing a resin film with an attached PSA film thereon causes the resin film (optical film) to be shrunk by heat with the PSA film adhering thereto, creating strain in the PSA layer of the PSA film attached to the resin film. Presumably, the PSA layer of the PSA films of Examples 1 to 7 dissipates this strain created inside it because it is flexible and fluidic under the annealing conditions by virtue of meeting a predetermined characteristics (tanδ) requirement. Presumably because of this, the laminate does not easily curl in the direction of shrinkage, and the absolute aveΔ(L) in the curl test is small. A PSA layer that dissipates strain created inside it does not interfere when a resin film deforms in association with the relief of residual stress and strain in it during annealing and, therefore, helps achieve sufficient relief of residual stress and strain in a resin film even if a PSA film has been attached to the resin film. The PSA layer of the PSA films of Comparative Examples 1 to 4, on the other hand, presumably holds the strain inside it because it does not meet the predetermined characteristics requirement. The laminate, therefore, curls in the direction of shrinkage, and the absolute aveΔ(L) in the curl test is large. A PSA layer that holds strain created inside it restricts the deformation of a resin film when the resin film is going to deform in association with the relief of residual stress and strain in it during annealing. With such a PSA layer, therefore, the relief of residual stress and strain in the resin film is insufficient.

The PSA films of Examples 1 to 7, furthermore, was highly adhesive until they were irradiated with active energy radiation. Irradiation with active energy radiation after the annealing of the resin film (optical film) greatly reduced their adhesion, allowing them to be easily peeled off, leaving no adhesive.

Of the PSA films of Examples 1 to 7, furthermore, those of Examples 1 to 6 in particular exhibited shape stability; they were sufficiently conformable to a curved shape in the thermoforming test, with limited formation of wrinkles therein.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. A PSA film comprising:
a base material; and
a PSA layer on at least one side of the base material, wherein:
the PSA layer has a temperature region, within a range of 70° C. to 100° C., in which a loss tangent tanδ thereof at a frequency of 1 Hz is 0.8 or greater; and
the PSA film is configured to be peeled off through irradiation with active energy radiation.

2. The PSA film according to claim 1, wherein a gel fraction of the PSA layer is 50% by mass or less.

3. The PSA film according to claim 1, wherein a stress in the base material at 100% elongation at 150° C. is from 5 MPa to 60 MPa.

4. A surface protection film comprising the PSA film according to claim 1.

5. A carrier comprising the PSA film according to claim 1.

6. A laminate comprising:
the PSA film according to claim 1; and
a resin film on the PSA layer of the PSA film.

7. The laminate according to claim 6, wherein the resin film is an optical film.

8. A PSA film comprising:
a base material; and
a PSA layer on at least one side of the base material, wherein:
the PSA layer is a layer of a PSA composition containing an acrylic copolymer and an active energy radiation-curable compound and has a temperature region, within a range of 70° C. to 100° C., in which a loss tangent tanδ thereof at a frequency of 1 Hz is 0.8 or greater.

9. The PSA film according to claim 8, wherein a gel fraction of the PSA layer is 50% by mass or less.

10. The PSA film according to claim 8, wherein a stress in the base material at 100% elongation at 150° C. is from 5 MPa to 60 MPa.

11. A surface protection film comprising the PSA film according to claim 8.

12. A carrier comprising the PSA film according to claim 8.

13. A laminate comprising:
the PSA film according to claim 8; and
a resin film on the PSA layer of the PSA film.

14. The laminate according to claim 13, wherein the resin film is an optical film.

15. A method comprising the following in the indicated order:
attaching a resin film to the PSA layer of the PSA film according to claim 1 to obtain a laminate;
annealing the resin film of the laminate; and
irradiating the laminate after the annealing with active energy radiation to peel the PSA film off the resin film.

16. A method comprising the following in the indicated order:
attaching a resin film to the PSA layer of the PSA film according to claim 8 to obtain a laminate;
annealing the resin film of the laminate; and
irradiating the laminate after the annealing with active energy radiation to peel the PSA film off the resin film.
